(19) United States
(12) Patent Application Publication
(10) Pub. No.: US 2026/0367412 A1
(43) Pub. Date: Nov. 19, 2026

(54) GRAVITY COMPENSATION MECHANISM ADAPTED TO HEAD-MOUNTED DEVICE AND HEAD-MOUNTED SMART DEVICE

(71) Applicant: HangZhou YuShu TECHNOLOGY CO.,LTD., Hangzhou (CN)

(72) Inventor: Xingxing WANG, Hangzhou (CN)

(21) Appl. No.: 19/108,382

(22) PCT Filed: Mar. 11, 2024
(86) PCT No.: PCT/CN2024/080950

§ 371 Date: Mar. 3, 2025

(30) Foreign Application Priority Data
Jan. 26, 2024 (CN) 202410115719.3
Jan. 29, 2024 (CN) 202410122085.4

(51) Int. Cl. G02B 27/01

(52) U.S. Cl. CPC G02B 27/0176; G02B 2027/0152; G02B 2027/0154; G02B 2027/0169

(57) ABSTRACT

The present invention relates to the technical field of head-mounted smart devices, and discloses a gravity compensation mechanism adapted to a head-mounted device and a head-mounted smart device. The gravity compensation mechanism adapted to a head-mounted smart device provided by the present invention includes a first support member fixed on the body of a user or an object around the user; a second support member movably connected to the first support member and cooperating with the first support member to provide a gravity-overcoming support force for the head-mounted smart device; and a drive unit provided between the first support member and the second support member or on the second support member, where a driving force is provided for the head-mounted smart device in the vertical direction based on a rotation trend of the head of the user in the vertical direction, alleviating poor use experience such as head and face discomfort and neck soreness that is caused by long-time wearing of the head-mounted smart device, thereby improving the use experience of the user for the head-mounted smart device, which is conducive to the promotion and use of the head-mounted smart device.

### TECHNICAL FIELD

The present invention relates to the technical field of head-mounted smart devices, and in particular to a gravity compensation mechanism adapted to a head-mounted device and a head-mounted smart device.

### BACKGROUND ART

Currently, most of existing head-mounted smart devices, such as VR glasses, are heavy and each have a weight focusing on a part in front of the head of a user. A head-mounted smart device is typically secured to the head of the user using a plurality of straps, to bear the weight of the entire head-mounted smart device relying on the head of the user. Therefore, long-time use thereof may result in discomforting use experience of the user, such as face discomfort and neck soreness. Moreover, for the head-mounted smart device having a weight focusing on a part thereof, such as VR glasses, the inertia of the device during rotation of the head of the user is large. Due to the absence of driving and support by an external force, the use experience is also poor.

Furthermore, a Chinese patent (with a publication number CN213957751U) discloses a head-mounted device, where an elastic arm to be located on the head of a user is added to a body of the head-mounted device. The elastic arm includes a front section and a rear section connected in sequence, where the front section is connected to the top of the body and extends toward the upper side of the body, and the rear section extends from an end of the front section toward the backside of the body. A support pad protruding toward the backside of the body is provided on the inner side of the front section, and a movable counterweight is provided on the rear section in the length direction of the elastic arm. The body, the elastic arm, the support pad, and the counterweight are equivalent to a lever, the support pad is a fulcrum, the elastic arms on two sides of the support pad are a power arm and a resistance arm, respectively, and the counterweight and the gravity applied to the body provide power and resistance, respectively. According to the lever principle, an upward force is applied to the body, thereby reducing pressure on the nose bridge and eyes and improving the degree of comfort during wearing by the user.

### SUMMARY OF THE INVENTION

### Technical Problems

The above solution relieves the pressure of the head-mounted device on the nose bridge and the eyes by providing the elastic arm and supporting the elastic arm with the top of the head. However, such a relief effect is very limited, and pressure on the top of the head is increased, causing discomfort to the user, and resulting in poor user experience, which is not conducive to the promotion and use of the head-mounted smart device.

The information disclosed in the Background Art is used only for understanding the background of the conception of the present invention, and thus may include information that does not constitute the prior art.

### Technical Solutions

To address the above problems or one of the above problems, the first objective of the present invention is to provide a gravity compensation mechanism adapted to a head-mounted smart device, which can actively provide support and adjustment based on use conditions of the head-mounted smart device.

To address the above problems or one of the above problems, the second objective of the present invention is to provide a gravity compensation mechanism adapted to a head-mounted smart device, where a first support member and a second support member are provided to transfer the weight of the head-mounted smart device to the body of the user or a surrounding object, so as to reduce or completely counteract the weight to be borne by the head of the user, thereby achieving gravity compensation for the head-mounted smart device; additionally, a connecting member is provided to enable relative rotation between the first support member and the second support member, so as to enable the head-mounted smart device to move as the head of the user moves. The structure is simple and practical, and the solution is feasible.

To address the above problems or one of the above problems, the third objective of the present invention is to provide a gravity compensation mechanism adapted to a head-mounted smart device and a head-mounted smart device, where a first support member, a second support member, and a related connecting member are provided, so as to compensate for the gravity of the head-mounted smart device on the one hand, and achieve changes in a position and posture of the head-mounted smart device on the other hand, alleviating or avoiding poor use experience such as head and face discomfort and neck soreness of the user that is caused by long-time wearing of the head-mounted smart device. Furthermore, the head of the user can move freely without restriction, improving the use experience of the user for the head-mounted smart device, which is conducive to the promotion and use of the head-mounted smart device.

In order to achieve one of the above objectives, the first technical solution of the present application is as follows:
a gravity compensation mechanism adapted to a head-mounted smart device, including:
a first support member configured to be fixed on the body of a user or an object around the user;
a second support member configured to be movably connected to the first support member and cooperate with the first support member to provide a gravity-overcoming support force for the head-mounted smart device;
a drive unit provided between the first support member and the second support member or provided on the second support member, and configured to, in cooperation with rotation of the head of the user in a vertical direction, provide a driving force for the head-mounted smart device in the vertical direction; and/or
a horizontal movable rotating shaft provided between the first support member and the second support and/or within the first support member or the second support member, and configured to, when the head of the user rotates in a horizontal direction, enable the second support member to rotate relative to the first support member following the rotation of the head of the user.

Furthermore, the drive unit providing a driving force in the vertical direction for the head-mounted smart device as described in the present application means that power provided by the drive unit can be decomposed to result in the driving force in the vertical direction, rather than that the drive unit can only provide the driving force in the vertical direction. That is, in some scenarios, driving forces in other directions may also exist. For example, the power provided by the drive unit may be a driving force inclined upward, to enable the head-mounted smart device to perform an upward inclined movement, which can be decomposed to result in a movement trend in the vertical direction.

Similarly, a rotation trend of the head of the user in the vertical direction as described in the present application means that the movement of the head can be decomposed to result in a displacement in the vertical direction, such as a head raising movement of the user, rather than that the head moves only in the vertical direction. The term “between” of the present application should be understood as “within”, “among”, “middle”, a spatial region, or a connection between two objects. The term “in” of the present application should be understood as “inside”. Therefore, a horizontal movable rotating shaft of the present application can be provided on a part or spatial region of a first support member or inside the first support member, can be provided on a part or spatial region of a second support member or inside the second support member, or can be provided at a connection between the first support member and the second support member. The phrase “the second support member is capable of rotating relative to the first support member following the rotation of the head of the user” should be understood as: a part of the second support member or the entire second support member is capable of rotating relative to the first support member following the rotation of the head of the user.

As an exemplary technical measure:
the first support member includes a first support rod capable of being vertically fixed on body of the user, and the second support member comprises an L-shaped support rod or arc-shaped support rod capable of being provided near the head of the user;
one end of the L-shaped support rod or arc-shaped support rod is directly or indirectly connected to the head-mounted smart device, and the other end thereof is connected to the first support rod via the drive unit; the indirect connection between the L-shaped support rod or arc-shaped support rod and the head-mounted smart device is indirect connection implemented using a flexible material or traction rope.

When the L-shaped support rod or arc-shaped support rod is directly connected to the head-mounted smart device, the head-mounted smart device can be directly driven to swing by the drive unit, so as to support and adjust the head-mounted smart device, thereby improving the use experience of the user.

Alternatively, the drive unit drives the traction rope via a reel to indirectly drive the head-mounted smart device; one end of the traction rope is directly connected to the drive unit, and the other end thereof is directly connected to the head-mounted smart device; or a guide assembly is provided along or at a bending position along the traction rope, the guide assembly being a pulley, a slide rail, a through-hole, a limiting protrusion, or/and a groove; the drive unit is an elastic drive mechanism or a motor capable of force controlling.

As an exemplary technical measure:
the L-shaped support rod or arc-shaped support rod is locatable to the top of the head of the user or to two sides of the head of the user; or the L-shaped support rod or arc-shaped support rod is a part of a head fixing strap of the head-mounted smart device.

As an exemplary technical measure:
the first support member includes a third support rod capable of being vertically fixed on a chair on which the user sits, a table beside the user, or a surrounding fixed object, and the second support member comprises a fourth support rod capable of being provided on the top of the head of the user.

In this technical solution, the first support member and the second support member can be placed on a table or chair beside the user, so that the user himself does not bear the weight of the head-mounted smart device, resulting in better use experience of the user.

One end of the fourth support rod is movably connected to the third support rod, the drive unit is fixed on the fourth support rod or the third support rod, and the drive unit is connected to the head-mounted smart device by rotationally winding or unwinding the traction rope; the horizontal movable rotating shaft is provided on the third support rod or the fourth support rod;
one end of the traction rope driven by the drive unit is directly connected to the drive unit, and the other end thereof is directly connected to the head-mounted smart device; or a guide assembly is provided along or at a bending position along the traction rope, the guide assembly being a pulley, a slide rail, a through-hole, a limiting protrusion, or/and a groove;
the drive unit is an elastic drive mechanism or a motor capable of force controlling.

In order to achieve one of the above objectives, the second technical solution of the present application is as follows:
a gravity compensation mechanism adapted to a head-mounted smart device, including a first support member capable of being fixed on the body of a user or an object around the user, and a second support member capable of compensating for the gravity applied to the head-mounted smart device, where
the first support member is movably connected to the second support member via a connecting member, so as to cooperate with a movement of the head of the user.

In the present invention, after continuous exploration and experimentation, the first support member and the second support member are provided to transfer the weight of the head-mounted smart device to the body of the user or a surrounding object, so as to reduce or completely counteract the weight to be borne by the head of the user, thereby achieving gravity compensation for the head-mounted smart device; additionally, the connecting member is provided to enable relative rotation between the first support member and the second support member, so as to enable the head-mounted smart device to move as the head of the user moves. The structure is simple and practical, and the solution is feasible.

Moreover, in the present invention, the first support member, the second support member, and the related connecting member are provided, so as to compensate for the gravity of the head-mounted smart device on the one hand, and achieve changes in a position and posture of the head-mounted smart device on the other hand, alleviating or avoiding poor use experience such as head and face discomfort and neck soreness of the user that is caused by long-time wearing of the head-mounted smart device. Furthermore, the head of the user can move freely without restriction, improving the use experience of the user for the head-mounted smart device, which is conducive to the promotion and use of the head-mounted smart device.

As an exemplary technical measure:
one of the first support member and the second support member is equipped with a drive unit configured to adjust a vertical position and/or posture of the head-mounted smart device;
the drive unit includes one or more rotary motors and controls the position and/or posture of the head-mounted smart device via a connecting rod or a traction rope; or the drive unit includes at least one hydraulic rod, pneumatic rod, or linear motor and controls the position and/or posture of the head-mounted smart device via a connecting rod or a traction rope.

Preferably, the drive unit is a rotary motor, making it possible to reduce manufacturing costs and making the structure simple and compact.

As an exemplary technical measure:
the first support member is a first support rod, two second support rods capable of being vertically fixed on the body of the user, a support frame capable of being placed on a surrounding object, a loop or a strap-shaped structure capable of sleeving the body of the user, a hook, a suction cup, a magnetic assembly, or a telescopic rod;
preferably, the first support member is a telescopic rod, facilitating adjustment of a vertical extension length of the first support member, to adapt to use by users of different heights.

And/or the second support member is an L-shaped support rod capable of surrounding the head of the user, two arc-shaped support rods capable of being symmetrically provided on two sides of the head of the user, an n-shaped rod, an n-shaped bracket, a fork-shaped structure, a Y-shaped bracket capable of being placed in front of the chest of the user, a rod-shaped structure, or a telescopic structure;
preferably, the second support member is a telescopic structure, facilitating adjustment of a transverse extension length of the second support member, to adapt to use by users of different weights.

And/or the connecting member is a hinge, a horizontal movable rotating shaft, a universal joint, a limiting member capable of enabling the first support member and the second support member to horizontally rotate, or a swing member with damping.

As an exemplary technical measure:
the first support member is a first support rod, an upper end thereof is connected to the second support member, and a strap-shaped structure configured to be bound to the user is provided at a lower end thereof;
the second support member is an L-shaped support rod capable of surrounding the head of the user, and a transverse portion thereof is connected to the head-mounted smart device;
the connecting member is a limiting member capable of enabling the first support member and the second support member to horizontally rotate;
one of the first support member and the second support member is equipped with a drive unit configured to adjust a vertical position of the head-mounted smart device, the drive unit including a rotary motor and a traction rope;
during use, the first support rod is fixed to the body of the user via the strap-shaped structure, the user wears the head-mounted smart device, and the weight of the head-mounted smart device is transferred to the body of the user sequentially via the traction rope, the second support rod, and the first support rod, thereby reducing or counteracting a weight to be borne by the head of the user to achieve gravity compensation for the head-mounted smart device;
when the user needs to turn the head thereof, the second support member is driven to rotate on the first support member, so as to change a horizontal position of the head-mounted smart device;
when the user needs to raise or lower the head thereof, the traction rope is driven to move upward or downward, and the rotary motor senses a change of the traction rope and winds or unwinds the traction rope, achieving a free change in a posture of the head-mounted smart device while performing real-time gravity compensation for the head-mounted smart device.

In order to achieve one of the above objectives, the third technical solution of the present application is as follows:
a head-mounted smart device having a gravity compensation effect, including a head-mounted smart device, a first support member capable of being fixed on the body of a user or an object around the user, and a second support member capable of compensating for the gravity of the head-mounted smart device, where the head-mounted smart device is connected to the second support member;
the first support member is movably connected to the second support member via a connecting member, so as to cooperate with a movement of the head of the user.

In the present invention, the first support member, the second support member, and the related connecting member are provided, so as to compensate for the gravity of the head-mounted smart device on the one hand, and achieve changes in a position and posture of the head-mounted smart device on the other hand, alleviating or avoiding poor use experience such as head and face discomfort and neck soreness of the user that is caused by long-time wearing of the head-mounted smart device. Furthermore, the head of the user can move freely without restriction, improving the use experience of the user for the head-mounted smart device, which is conducive to the promotion and use of the head-mounted smart device.

As an exemplary technical measure:
the first support member is a first support rod, an upper end thereof is connected to the second support member, and a strap-shaped structure configured to be bound to the user is provided at a lower end thereof;
the second support member is an L-shaped support rod capable of surrounding the head of the user, and a transverse portion thereof is connected to the head-mounted smart device;
the connecting member is a universal joint with damping;
during use, the first support rod is fixed to the body of the user via the strap-shaped structure, the user wears the head-mounted smart device, and the weight of the head-mounted smart device is transferred to the body of the user via the second support rod and the first support rod, thereby reducing or counteracting a weight to be borne by the head of the user to achieve gravity compensation for the head-mounted smart device;
when the user needs to turn, raise, or lower the head thereof, the second support member is drive to overcome resistance of the universal joint, and the second support member is positioned on the first support member via the damping, achieving a free change in a posture of the head-mounted smart device. The solution is practical and easy to manufacture.

### Beneficial Effects

In the present invention, after continuous exploration and experimentation, the first support member and the second support member are provided to transfer the weight of the head-mounted smart device to the body of the user or a surrounding object, so as to reduce or completely counteract the weight to be borne by the head of the user, thereby achieving gravity compensation for the head-mounted smart device; additionally, the connecting member is provided to enable relative rotation between the first support member and the second support member, so as to enable the head-mounted smart device to move as the head of the user moves. The structure is simple and practical, and the solution is feasible.

Moreover, in the gravity compensation mechanism adapted to a head-mounted smart device provided by the present invention, the first support member and the second support member are provided to support the head-mounted smart device; and the drive unit is used to drive the head-mounted smart device, so as to adjust the height of the head-mounted smart device, alleviating poor use experience such as head and face discomfort and neck soreness that is caused by long-time wearing of the head-mounted smart device. At the same time, for cooperation with the rotation of the head of the user, the horizontal movable rotating shaft is added to actively cooperate with the driving, enabling the head of the user to move freely without restriction. The use of the gravity compensation mechanism improves the use experience of the user for the head-mounted smart device.

Furthermore, in the present invention, the first support member, the second support member, and the related connecting member are provided, so as to compensate for the gravity of the head-mounted smart device on the one hand, and achieve changes in a position and posture of the head-mounted smart device on the other hand, alleviating or avoiding poor use experience such as head and face discomfort and neck soreness of the user that is caused by long-time wearing of the head-mounted smart device. Furthermore, the head of the user can move freely without restriction, improving the use experience of the user for the head-mounted smart device, which is conducive to the promotion and use of the head-mounted smart device.

The present invention is further described in detail below with reference to the drawings and specific embodiments.

### BRIEF DESCRIPTION OF THE DRAWINGS

FIG. 1 is a schematic diagram of an overall structure of a gravity compensation mechanism according to the first embodiment of the present invention;

FIG. 2 is a schematic diagram of wearing of the gravity compensation mechanism by a user according to the first embodiment of the present invention;

FIG. 3 is a schematic diagram of an overall structure of a gravity compensation mechanism according to the second embodiment of the present invention;

FIG. 4 is a schematic diagram of wearing of the gravity compensation mechanism by a user according to the second embodiment of the present invention;

FIG. 5 is a schematic diagram of wearing of the gravity compensation mechanism by a user according to the third embodiment of the present invention;

FIG. 6 is a schematic diagram of wearing of the gravity compensation mechanism by a user according to the fourth embodiment of the present invention;

FIG. 7 is a schematic diagram of wearing of the gravity compensation mechanism by a user according to the fifth embodiment of the present invention;

FIG. 8 is a schematic diagram of wearing of the gravity compensation mechanism by a user according to the sixth embodiment of the present invention; and

FIG. 9 is a schematic diagram of an overall structure of a gravity compensation mechanism according to the seventh embodiment of the present invention.

### LIST OF REFERENCE SIGNS

1—first support rod; 2—L-shaped support rod; 3—drive unit; 4—horizontal movable rotating shaft; 5—arc-shaped support rod; 6—second support rod; 7—third support rod; 8—fourth support rod; 9—head-mounted smart device; 10—user; 11—pulley; 12—traction rope; 13—back fixing rod; 14—output rocker arm; 15—strap-shaped structure.

### DETAILED DESCRIPTION OF THE EMBODIMENTS

The present application will be further described below with reference to the embodiments and the drawings. It should be noted that the embodiments or technical features described below may be freely combined to form new embodiments on the premise of not causing any conflict.

It should be noted that when two elements are “rotatably connected” or “movably connected”, the two elements may be directly connected or be connected via an intermediate element. On the contrary, when an element is referred to as being “directly on” another element, there is no intermediate element. The terms “horizontal”, “vertical”, “transverse”, “upper”, “lower”, and similar expressions used herein are for descriptive purposes only.

Unless otherwise defined, all technical and scientific terms used herein have the same meanings as those commonly understood by those skilled in the technical field of the present application. The terms used herein are only for the purpose of describing specific embodiments and are not intended to limit the present application. The term “and/or” used herein includes any and all combinations of one or more listed items related thereto.

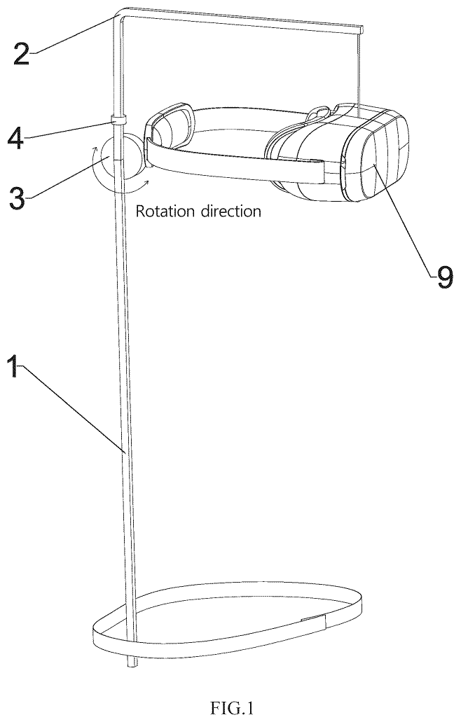

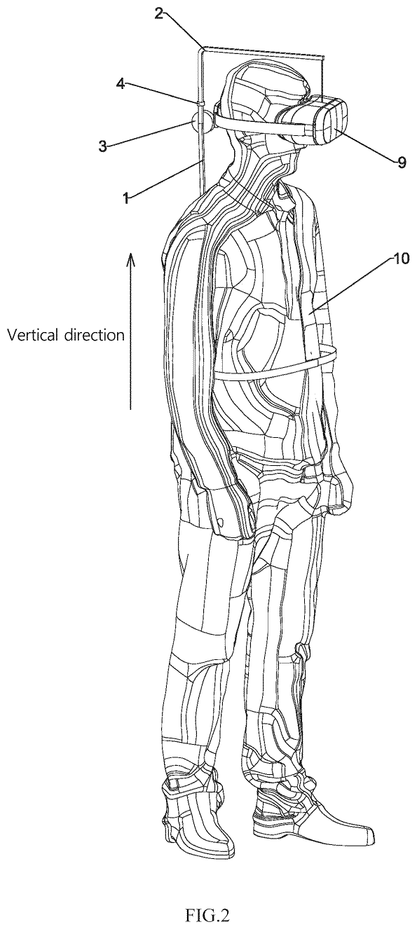

Referring to FIGS. 1 and 2, the first specific embodiment of a gravity compensation mechanism adapted to a head-mounted smart device provided by the present invention is as follows:
the gravity compensation mechanism adapted to a head-mounted smart device includes a first support member, a second support member, a drive unit 3, and a horizontal movable rotating shaft 4.

The first support member is fixed on the body of a user 10 or an object around the user 10; and the second support member is movably connected to the first support member and cooperates with the first support member to provide a gravity-overcoming support force for the head-mounted smart device 9.

The drive unit 3 is provided between the first support member and the second support member, and is capable of, based on a rotation trend of the head of the user 10 in a vertical direction, providing a driving force for the head-mounted smart device 9 in the vertical direction.

The horizontal movable rotating shaft 4 is provided on the second support member, and when the head of the user 10 rotates in a horizontal direction, enables the second support member to rotate relative to the first support member following the rotation of the head of the user 10.

The first support member includes a first support rod 1 vertically fixed on the body of the user 10, and the second support member includes an L-shaped support rod 2 provided on the top of the head of the user 10. One end of the L-shaped support rod 2 is directly or indirectly connected to the head-mounted smart device 9, and the other end thereof is connected to the first support rod 1.

In this embodiment of the present invention, the second support member is directly driven by the drive unit 3, or the height of the head-mounted smart device 9 is adjusted via the traction rope assembly, so as to improve use experience of the user 10.

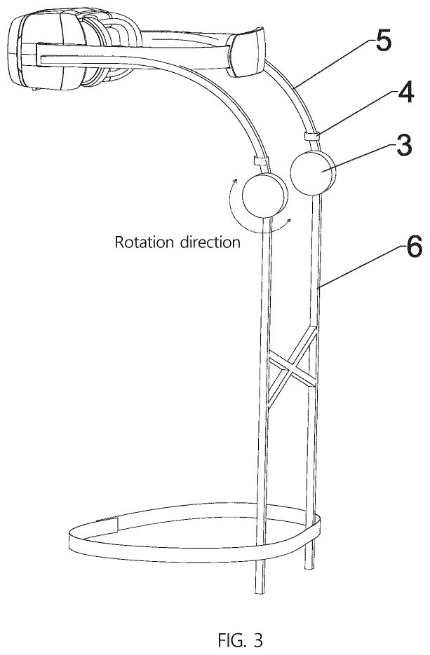

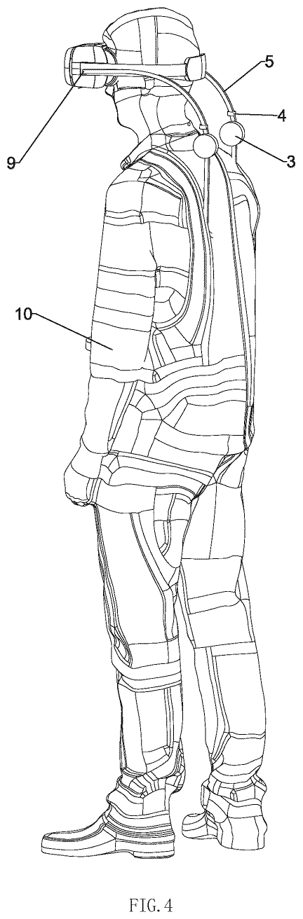

Referring to FIGS. 3 and 4, the second specific embodiment of a gravity compensation mechanism adapted to a head-mounted smart device provided by the present invention is as follows:
this embodiment differs from the first specific embodiment mainly in that: the first support member includes two second support rods 6 vertically fixed on the body of the user 10, and the second support member includes two arc-shaped support rods 5 symmetrically provided on two sides of the head of the user 10.

One end of the arc-shaped support rod 5 is directly connected to the head-mounted smart device 9, and the other end thereof is directly connected to the first support rod 1 via the drive unit 3 and the horizontal movable rotating shaft 4. In this embodiment, the arc-shaped support rod 5 connected to the head-mounted smart device 9 acts as a rocker arm, which is directly driven to rock in the vertical direction by the drive unit 3 fixedly connected to the first support rod 1, so as to form a double-rod rocker arm structure, supporting and adjusting the head-mounted smart device 9, and thereby improving the use experience of the user 10.

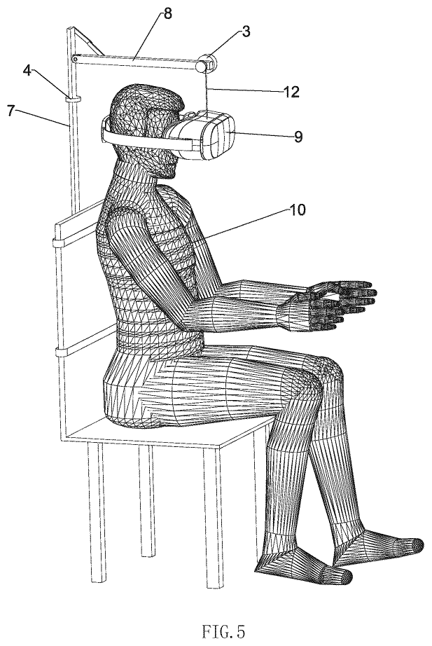

Referring to FIG. 5, the third specific embodiment of a gravity compensation mechanism adapted to a head-mounted smart device provided by the present invention is as follows:
this embodiment differs from the first specific embodiment mainly in that: the first support member includes a third support rod 7 vertically fixed on a chair on which the user 10 sits, and the second support member includes a fourth support rod 8 provided on the top of the head of the user 10. A horizontal movable rotating shaft 4 is provided on the third support rod 7, one end of the fourth support rod 8 is movably connected to the third support rod 7, and the drive unit 3 is provided at the other end thereof. The drive unit 3 is connected to the head-mounted smart device 9 via a traction rope 12.

In this embodiment, the first support member and the second support member are placed on a chair on which the user 10 sits, so that the user 10 himself does not bear the weight of the head-mounted smart device 9, resulting in better use experience of the user 10.

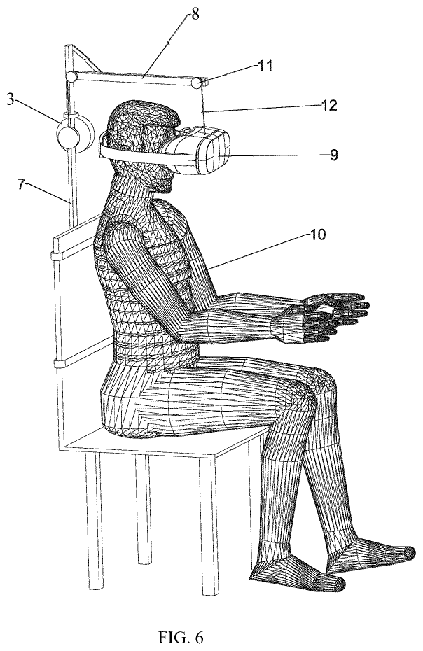

Referring to FIG. 6, the fourth specific embodiment of a gravity compensation mechanism adapted to a head-mounted smart device provided by the present invention is as follows:
this embodiment differs from the third specific embodiment mainly in that: the horizontal movable rotating shaft 4 and the drive unit 3 are both provided on the third support rod 7, one end of the fourth support rod 8 is movably connected to the third support rod 7, and a pulley 11 is provided at the other end thereof. The drive unit 3 is connected to the head-mounted smart device 9 via a traction rope 12 and the pulley 11.

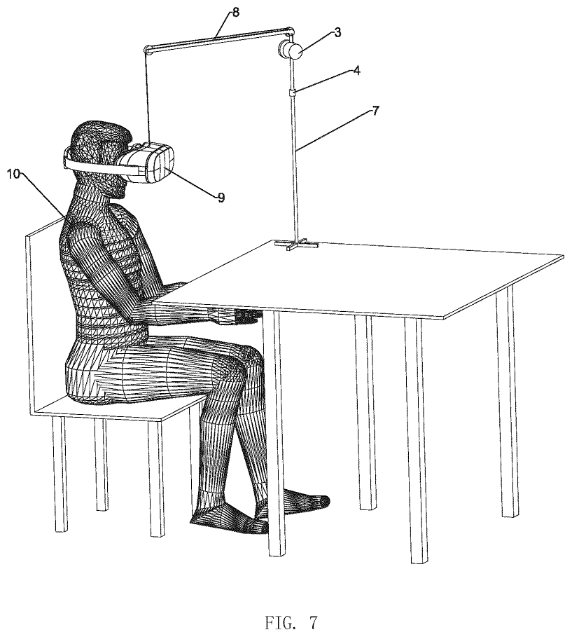

Referring to FIG. 7, the fifth specific embodiment of a gravity compensation mechanism adapted to a head-mounted smart device provided by the present invention is as follows:
this embodiment differs from the fourth specific embodiment mainly in that: the third support rod 7 is vertically fixed on a table beside the user 10, and the fourth support rod 8 is provided on the top of the head of the user 10. In this embodiment, the third support rod 7 and the fourth support rod 8 are placed on a table beside the user 10, so that the user 10 himself does not bear the weight of the head-mounted smart device 9, resulting in better use experience of the user 10.

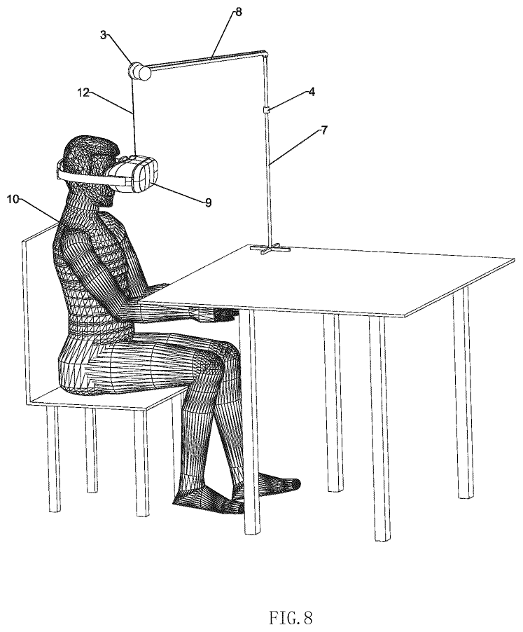

Referring to FIG. 8, the sixth specific embodiment of a gravity compensation mechanism adapted to a head-mounted smart device provided by the present invention is as follows:
this embodiment differs from the fifth specific embodiment mainly in that: the horizontal movable rotating shaft 4 is provided on the third support rod 7, and the drive unit 3 is provided at the end of the fourth support rod 8. One end of the fourth support rod 8 is rotatably connected to the third support rod 7, and the drive unit 3 is provided at the other end thereof.

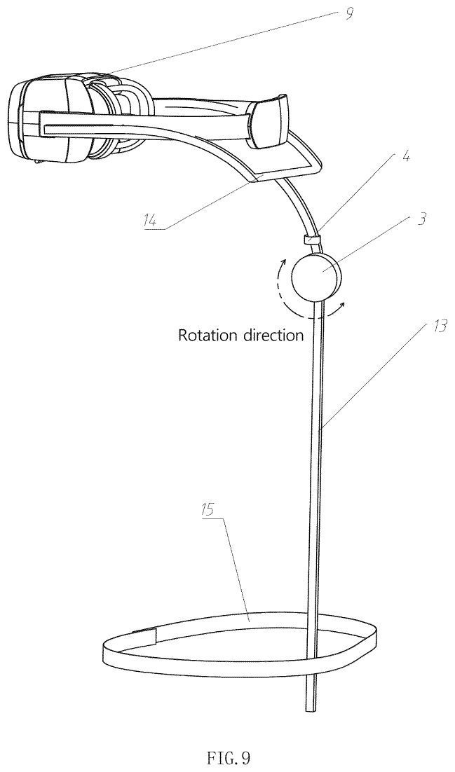

Referring to FIG. 9, the seventh specific embodiment of a gravity compensation mechanism adapted to a head-mounted smart device provided by the present invention is as follows:
the gravity compensation mechanism adapted to a head-mounted smart device includes a first support member, a second support member, a drive unit 3, and a horizontal movable rotating shaft 4.

The first support member is a back fixing rod 13, which is fixed to the body of the user 10 via a strap-shaped structure 15. The second support member is an output rocker arm 14, which is movably connected to the back fixing rod 13 and cooperates with the back fixing rod 13 to provide a gravity-overcoming support force for the head-mounted smart device 9.

The drive unit 3 is a motor, which is provided between the back fixing rod 13 and the output rocker arm 14, and is capable of, based on a rotation trend of the head of the user 10 in the vertical direction, providing a driving force for the head-mounted smart device 9 in the vertical direction.

The horizontal movable rotating shaft 4 is provided on the output rocker arm 14, and when the head of the user 10 rotates in the horizontal direction, enables the output rocker arm 14 to rotate relative to the back fixing rod 13 following the rotation of the head of the user 10.

The output rocker arm 14 is a fork-shaped structure or Y-shaped structure, so as to enhance the structural strength of the output rocker arm 14, facilitating effective support of the head-mounted smart device 9.

The eighth specific embodiment of a gravity compensation mechanism adapted to a head-mounted smart device provided by the present invention is as follows:
the gravity compensation mechanism adapted to a head-mounted smart device includes a first support member capable of being fixed on the body of a user 10 or an object around the user 10, and a second support member capable of compensating for the gravity applied to the head-mounted smart device 9, where the first support member is movably connected to the second support member via a connecting member, so as to cooperate with a movement of the head of the user 10.

The first support member is a first support rod 1, an upper end thereof is connected to the second support member, and a strap-shaped structure configured to be bound to the user 10 is provided at a lower end thereof. The second support member is an L-shaped support rod 2 capable of surrounding the head of the user 10, and a transverse portion thereof is connected to the head-mounted smart device 9. The connecting member is a limiting member capable of enabling the first support member and the second support member to horizontally rotate.

One of the first support member and the second support member is equipped with a drive unit 3 configured to adjust a vertical position of the head-mounted smart device 9, the drive unit 3 including a rotary motor and a traction rope 12.

During use, the first support rod 1 is fixed to the body of the user 10 via the strap-shaped structure, the user 10 wears the head-mounted smart device 9, and the weight of the head-mounted smart device 9 is transferred to the body of the user 10 sequentially via the traction rope 12, the second support rod 6, and the first support rod 1, thereby reducing or counteracting a weight to be borne by the head of the user 10 to achieve gravity compensation for the head-mounted smart device 9.

When the user 10 needs to turn the head thereof, the second support member is driven to rotate on the first support member, so as to change a horizontal position of the head-mounted smart device 9.

When the user 10 needs to raise or lower the head thereof, the traction rope 12 is driven to move upward or downward, and the rotary motor senses a change of the traction rope 12 and winds or unwinds the traction rope, achieving a free change in a posture of the head-mounted smart device 9 while performing real-time gravity compensation for the head-mounted smart device 9.

A specific embodiment of a head-mounted smart device with the gravity compensation mechanism provided by the present invention is as follows:
the head-mounted smart device having a gravity compensation effect includes a head-mounted smart device, a first support member capable of being fixed on the body of a user 10 or an object around the user 10, and a second support member capable of compensating for the gravity of the head-mounted smart device, where the head-mounted smart device is connected to the second support member; and the first support member is movably connected to the second support member via a connecting member, so as to cooperate with a movement of the head of the user 10.

The first support member is a first support rod 1, an upper end thereof is connected to the second support member, and a strap-shaped structure configured to be bound to the user 10 is provided at a lower end thereof. The second support member is an L-shaped support rod 2 capable of surrounding the head of the user 10, and a transverse portion thereof is connected to the head-mounted smart device. The connecting member is a universal joint with damping.

During use, the first support rod 1 is fixed to the body of the user 10 via the strap-shaped structure, the user 10 wears the head-mounted smart device, and the weight of the head-mounted smart device is transferred to the body of the user 10 via the second support rod 6 and the first support rod 1, thereby reducing or counteracting a weight to be borne by the head of the user 10 to achieve gravity compensation for the head-mounted smart device 9.

When the user 10 needs to turn, raise, or lower the head thereof, the second support member is driven to overcome resistance of the universal joint, and the second support member is enabled to perform a corresponding movement on the first support member, achieving a free change in a posture of the head-mounted smart device. The solution is practical and easy to manufacture.

Finally, it should be noted that the above embodiments are only used to illustrate the technical solutions of the present application, rather than to limit them. Although the present application has been described in detail with reference to the above embodiments, those skilled in the art should understand that the specific embodiments of the present application may still be modified or replaced by equivalents, and any modifications or equivalent replacements that do not deviate from the spirit and scope of the present application shall be covered by the scope of protection of the claims of the present application.

1. A gravity compensation mechanism adapted to a head-mounted smart device, comprising:
a first support member configured to be fixed on the body of a user or an object around the user;
a second support member configured to be movably connected to the first support member and cooperate with the first support member to provide a gravity-overcoming support force for the head-mounted smart device;
a drive unit provided between the first support member and the second support member or provided on the second support member, and configured to, in cooperation with rotation of the head of the user in a vertical direction, provide a driving force for the head-mounted smart device in the vertical direction; and/or
a horizontal movable rotating shaft provided between the first support member and the second support and/or within the first support member or the second support member, and configured to, when the head of the user rotates in a horizontal direction, enable the second support member to rotate relative to the first support member following the rotation of the head of the user.

2. The gravity compensation mechanism adapted to a head-mounted smart device according to claim 1, wherein
the first support member comprises a first support rod capable of being vertically fixed on the body of the user, and the second support member comprises an L-shaped support rod or arc-shaped support rod capable of being provided near the head of the user;
one end of the L-shaped support rod or arc-shaped support rod is directly or indirectly connected to the head-mounted smart device, and the other end thereof is connected to the first support rod via the drive unit; the indirect connection between the L-shaped support rod or arc-shaped support rod and the head-mounted smart device is indirect connection implemented using a flexible material or traction rope;
or the drive unit drives the traction rope via a reel to indirectly drive the head-mounted smart device; one end of the traction rope is directly connected to the drive unit, and the other end thereof is directly connected to the head-mounted smart device; or a guide assembly is provided along or at a bending position along the traction rope, the guide assembly being a pulley, a slide rail, a through-hole, a limiting protrusion, or/and a groove;
the drive unit is an elastic drive mechanism or a motor capable of force controlling.

3. The gravity compensation mechanism adapted to a head-mounted smart device according to claim 2, wherein
the L-shaped support rod or arc-shaped support rod is locatable to the top of the head of the user or to two sides of the head of the user; or the L-shaped support rod or arc-shaped support rod is a part of a head fixing strap of the head-mounted smart device.

4. The gravity compensation mechanism adapted to a head-mounted smart device according to claim 1, wherein
the first support member comprises a third support rod capable of being vertically fixed on a chair on which the user sits, a table beside the user, or a surrounding fixed object, and the second support member comprises a fourth support rod capable of being provided on the top of the head of the user;
one end of the fourth support rod is movably connected to the third support rod, the drive unit is fixed on the fourth support rod or the third support rod, and the drive unit is connected to the head-mounted smart device by rotationally winding or unwinding the traction rope; the horizontal movable rotating shaft is provided on the third support rod or the fourth support rod;
one end of the traction rope driven by the drive unit is directly connected to the drive unit, and the other end thereof is directly connected to the head-mounted smart device; or a guide assembly is provided along or at a bending position along the traction rope, the guide assembly being a pulley, a slide rail, a through-hole, a limiting protrusion, or/and a groove;
the drive unit is an elastic drive mechanism or a motor capable of force controlling.

5. A gravity compensation mechanism adapted to a head-mounted smart device,
comprising a first support member capable of being fixed on the body of a user or an object around the user, and a second support member capable of compensating for the gravity applied to the head-mounted smart device, wherein
the first support member is movably connected to the second support member via a connecting member, so as to cooperate with a movement of the head of the user.

6. The gravity compensation mechanism adapted to a head-mounted smart device according to claim 5, wherein
one of the first support member and the second support member is equipped with a drive unit configured to adjust a vertical position and/or posture of the head-mounted smart device;
the drive unit comprises one or more rotary motors and controls the position and/or posture of the head-mounted smart device via a connecting rod or a traction rope; or the drive unit comprises at least one hydraulic rod, pneumatic rod, or linear motor and controls the position and/or posture of the head-mounted smart device via a connecting rod or a traction rope.

7. The gravity compensation mechanism adapted to a head-mounted smart device according to claim 5, wherein
the first support member is a first support rod, two second support rods capable of being vertically fixed on the body of the user, a support frame capable of being placed on a surrounding object, a loop or a strap-shaped structure capable of sleeving the body of the user, a hook, a suction cup, a magnetic assembly, or a telescopic rod;
and/or the second support member is an L-shaped support rod capable of surrounding the head of the user, two arc-shaped support rods capable of being symmetrically provided on two sides of the head of the user, an n-shaped rod, an n-shaped bracket, a fork-shaped structure, a Y-shaped bracket capable of being placed in front of the chest of the user, a rod-shaped structure, or a telescopic structure;
and/or the connecting member is a hinge, a horizontal movable rotating shaft, a universal joint, a limiting member capable of enabling the first support member and the second support member to horizontally rotate, or a swing member with damping.

8. The gravity compensation mechanism adapted to a head-mounted smart device according to claim 5, wherein
the first support member is a first support rod, an upper end thereof is connected to the second support member, and a strap-shaped structure configured to be bound to the user is provided at a lower end thereof;
the second support member is an L-shaped support rod capable of surrounding the head of the user, and a transverse portion thereof is connected to the head-mounted smart device;
the connecting member is a limiting member capable of enabling the first support member and the second support member to horizontally rotate;
one of the first support member and the second support member is equipped with a drive unit configured to adjust a vertical position of the head-mounted smart device, the drive unit comprising a rotary motor and a traction rope;
during use, the first support rod is fixed to the body of the user via the strap-shaped structure, the user wears the head-mounted smart device, and the weight of the head-mounted smart device is transferred to the body of the user sequentially via the traction rope, the second support rod, and the first support rod, thereby reducing or counteracting a weight to be borne by the head of the user to achieve gravity compensation for the head-mounted smart device;
when the user needs to turn the head thereof, the second support member is driven to rotate on the first support member, so as to change a horizontal position of the head-mounted smart device;
when the user needs to raise or lower the head thereof, the traction rope is driven to move upward or downward, and the rotary motor senses a change of the traction rope and winds or unwinds the traction rope, achieving a free change in a posture of the head-mounted smart device while performing real-time gravity compensation for the head-mounted smart device.

9. A head-mounted smart device having a gravity compensation effect,
comprising a head-mounted smart device, a first support member capable of being fixed on the body of a user, and a second support member capable of compensating for the gravity of the head-mounted smart device, wherein
the head-mounted smart device is connected to the second support member;
the first support member is movably connected to the second support member via a connecting member, so as to cooperate with a movement of the head of the user.

10. The head-mounted smart device having a gravity compensation effect according to claim 9, wherein
the first support member is a first support rod, an upper end thereof being is connected to the second support member, and a strap-shaped structure configured to be bound to the user is provided at a lower end thereof;
the second support member is an L-shaped support rod capable of surrounding the head of the user, and a transverse portion thereof is connected to the head-mounted smart device;
the connecting member is a universal joint with damping;
during use, the first support rod is fixed to the body of the user via the strap-shaped structure, the user wears the head-mounted smart device, and the weight of the head-mounted smart device is transferred to the body of the user via the second support rod and the first support rod, thereby reducing or counteracting a weight to be borne by the head of the user to achieve gravity compensation for the head-mounted smart device;
when the user needs to turn, raise, or lower the head thereof, the second support member is driven to overcome resistance of the universal joint, and the second support member is positioned on the first support member via the damping, achieving a free change in a posture of the head-mounted smart device.
